(19) United States
(12) Patent Application Publication
(10) Pub. No.: US 2006/0074872 A1
(43) Pub. Date: Apr. 6, 2006

(54) Adaptive database buffer memory management using dynamic SQL statement cache statistics

(75) Inventor: Mark R. Gordon, Portland, OR (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/955,559

(22) Filed: Sep. 30, 2004

(51) Int. Cl. G06F 17/30

(52) U.S. Cl. 707/3

(57) ABSTRACT

The present invention provides a method, system, and computer program product for adaptive database buffer memory management using dynamic Structured Query Language (SQL) statement cache statistics. The method comprises: using SQL statement cache statistics to infer page re-use. The method further comprises: determining a use ratio of an SQL statement; comparing the use ratio of the statement to a threshold value; if the use ratio is less than the threshold value, setting a reclaim page attribute of the statement indicating a low likelihood of page re-use of pages referenced by the statement; and, if the reclaim page attribute of the statement is set: setting a quick reclaim attribute of each page read from disk by the statement; and after each page is released by the statement, placing the page in a buffer pool free list, wherein a memory location of the page in a buffer pool memory is immediately available for re-use.

### BACKGROUND OF THE INVENTION

1. Field of the Invention

The present invention generally relates to buffer memory management for database systems. More particularly, the present invention provides a method, system, and computer program product for adaptive database buffer memory management using dynamic Structured Query Language (SQL) statement cache statistics.

2. Related Art

When using database systems such as DB2, buffer pool tuning and table isolation are commonly used to optimize system performance. For instance, a large table that is often sequentially scanned with low re-use of data may be moved to a small buffer pool, so that the pages referenced in the table do not compete with other objects for pages in buffer pool memory.

The current buffer pool optimization process is based on the concept that tables (and indexes) have reference patterns and working sets. The goal of the buffer pool tuning process is to determine the reference patterns and working sets, and then configure the buffer pools and assign tables/indexes to the buffer pools. Generally, one of two goals is sought—either to give a table or index more memory than it would get if it were resident in a buffer pool with other tables and indexes, or to constrain the amount of memory available to a table or index, so that it gets less memory than it would if it shared a buffer pool with other tables and indexes. That is, the goal is to make use of knowledge about the application behavior to override the normal database buffer pool memory management process.

This activity of designing separate buffer pools (determining optimal size, finding candidates to be separated, etc.) is complex, requiring various traces and analysis tools. In addition, when using an application system such as SAP, where a table such as a customer master table may be accessed randomly at one time (e.g. customer lookup at a call center) and sequentially at others (e.g. during customer billing), then the “optimal” configuration reported by the analysis tools may be different depending on when the system was analyzed. For example, if the workload were analyzed during transaction processing, then one configuration might be optimal, while if the workload were analyzed during batch, a different configuration might be optimal.

After having created the separate buffer pools and having moved the tables/indexes, it can be difficult to determine the performance impact—which of the buffer pools may or may not be helping performance. As an example, in an environment such as SAP, which has thousands of tables and where there may be tens or hundreds of frequently used tables, customers often end up with as many as ten to twenty defined buffer pools, which creates a complex management and tuning process.

### SUMMARY OF THE INVENTION

In general, the present invention provides a method, system, and computer program product for adaptive database buffer memory management using dynamic Structured Query Language (SQL) statement cache statistics. In particular, the present invention infers the likelihood of future page reuse for a statement from SQL execution statistics gathered during previous executions of the statement.

The present invention addresses the situations where tables need to be moved to separate buffer pools to constrain their memory use. The present invention does not address the situation where tables are moved to separate buffer pools to give the table more memory than it would get if resident in a shared pool. Rather, the present invention limits buffer pool memory used for a table by a statement without moving tables into separate buffers. The present invention does not replace methods currently in place for managing buffer pages, such as limits on sequential or changed pages, or buffer management processes such as Least Recently Used (LRU) or First In First Out (FIFO) page management. Instead, the present invention offers a way to augment the process for managing memory in buffer pools by using information about the behavior of individual statements.

A first aspect of the present invention is directed to a method for database buffer memory management, comprising: inferring re-use of a page using Structured Query Language (SQL) statement cache statistics.

A second aspect of the present invention is directed to a system for database buffer memory management, comprising: a system for inferring re-use of a page using Structured Query Language (SQL) statement cache statistics.

A third aspect of the present invention is directed to a program product stored on a recordable medium for database buffer memory management, which when executed comprises: program code for inferring re-use of a page using Structured Query Language (SQL) statement cache statistics.

A fourth aspect of the present invention is directed to a method for deploying an application for database buffer memory management, comprising: providing a computer infrastructure being operable to infer re-use of a page using Structured Query Language (SQL) statement cache statistics.

A fifth aspect of the present invention is directed to computer software embodied in a propagated signal for database buffer memory management, the computer software comprising instructions to cause a computer system to infer re-use of a page using Structured Query Language (SQL) statement cache statistics.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a general flow diagram of a method in accordance with an embodiment of the present invention.

FIG. 2 depicts a more detailed flow diagram of a method in accordance with an embodiment of the present invention.

FIG. 3 depicts a system for implementing the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and computer program product for adaptive database buffer memory management using dynamic Structured Query Language (SQL) statement cache statistics.

Database systems using dynamic SQL maintain a variety of performance-related statistics for statements in the statement cache. These vary from system to system, but generally include statement ID, elapsed time, prepare time, page references (e.g., getpages in DB2), synchronous I/O, asynchronous I/O, copies being executed, etc. Historical page use ratios can be calculated using statistics for page references, I/O operations, and prefetched pages. Examples of the calculation of a page use ratio will be presented in detail below.

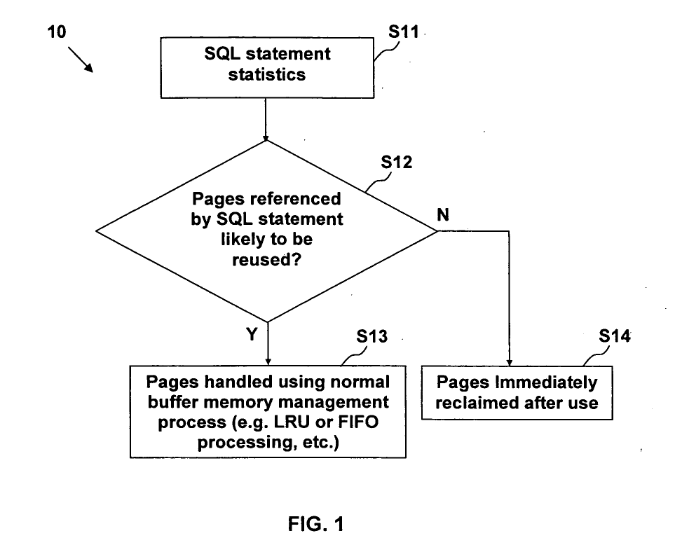

The present invention takes the SQL statement statistics, which are designed for use in performance analysis (e.g., locating inefficient SQL statements, finding statements having I/O delays or serialization constraints, etc.) and uses the SQL statement statistics to provide SQL-statement-level feedback to a database buffer management system. The feedback helps the database buffer management system determine at the time a statement is running whether the pages read in by and being referenced by the statement might be later re-used, and so should go through a normal buffer memory management process (e.g., LRU or FIFO processing), or if the pages can be immediately reclaimed after use, and thus bypass the normal buffer memory management process. That is, the database buffer management system uses the SQL statement statistics to determine if a statement has a page re-use pattern that allows the statement's buffer pool memory pages to be handled in a special way. This general process is depicted in the flow diagram 10 illustrated in FIG. 1. In step S11, SQL statement statistics are provided to the database buffer management system. In step S12, the database buffer management system determines, based on the SQL statement statistics, whether the pages referenced by a statement are likely to be reused. If so, the pages are handled using a normal buffer memory management process (step S13). If not, the pages are immediately reclaimed after use (step S14).

In the present invention, the phrase “individual SQL statement” refers to a unique character string which defines an SQL statement. If the statement defined by a unique character string is executed many times, it is still considered to be an “individual SQL statement.”

Previously, in systems using static SQL, there was not a straightforward way to determine the system-wide performance statistics for an individual SQL statement. With the advent of systems based completely on dynamic SQL, however, statistics for all executions of an individual SQL statement are aggregated in the statement cache statistics. This system-wide aggregation of statistics provides historical information that is used by the present invention to infer current and future activity, such as the likelihood that pages referenced by an executing statement will be re-used. Thus, the historical record of statement statistics can be used by the database buffer management system to decide how to handle pages referenced by a currently executing copy of the SQL statement.

In accordance with the present invention, a page use ratio is calculated as follows:
page use ratio=(pages referenced by a statement/max(pages read from disk for the statement,1))
The page use ratio (hereafter “use ratio”) is used to highlight that page re-use (that is, referencing a page more than once for each time that the page is read in from disk) is an important factor in deciding whether a page should go through the normal buffer management processes or whether the page of memory in the buffer pool can be immediately made available for the database buffer management system to reclaim, after the contents have been used and released by a statement. This is based on the proposition that if a statement does not reference pages already in buffer pool memory, then the pages that the statement reads in from disk are not likely to be re-used by other statements. A statement with a low use ratio is operating on a set of data that is largely distinct from data used by other statements executing in the system. A statement with a high use ratio is operating on a set of data used by other statements executing in the system. A use ratio of 1, for example, means that every page referenced by the statement was read in from disk for the statement.

Page re-use by a statement can happen in one of two ways:
(A) The page was already resident in buffer pool memory after having been read in from disk by another execution of a statement. In this case, if a statement is using pages which were previously read by another statement, then this method infers that it is likely that pages used by this statement will be used by other statements. This type of page re-use is an identification of commonality of data used by different statements, or by different executions of the same statement.
(B) The page is referenced more than once during the executing statement.
   In either case, if page re-use for a statement is above a certain limit, the pages the statement reads in and references should not be immediately reclaimed after release, but should go through the normal buffer memory management process.

Statements which have low use ratios in their SQL statement statistics will be assigned a special “reclaim page” attribute, so that when the statement is executed, the buffer pool memory containing pages referenced by the statement and accessed from disk can be quickly re-used after the statement releases the pages. The text of a statement, and its attributes (e.g., reclaim page, use ratio) can be saved outside the statement cache, so that a statement's reuse behavior can be later recognized from the statement history, rather than be re-evaluated from statement statistics. As noted above, a low use ratio shows that the data being accessed by the statement is distinct from the data referenced by other statements running in the database, and so it would probably not be beneficial to retain the data referenced by the statement.

When a statement running with a “reclaim page” attribute reads a page from disk into buffer pool memory, either synchronously or via prefetch, the buffer pool memory page will be set with a “quick reclaim” attribute. Thus, only the buffer pages read in from disk by a statement with a low use ratio will be eligible for special processing.

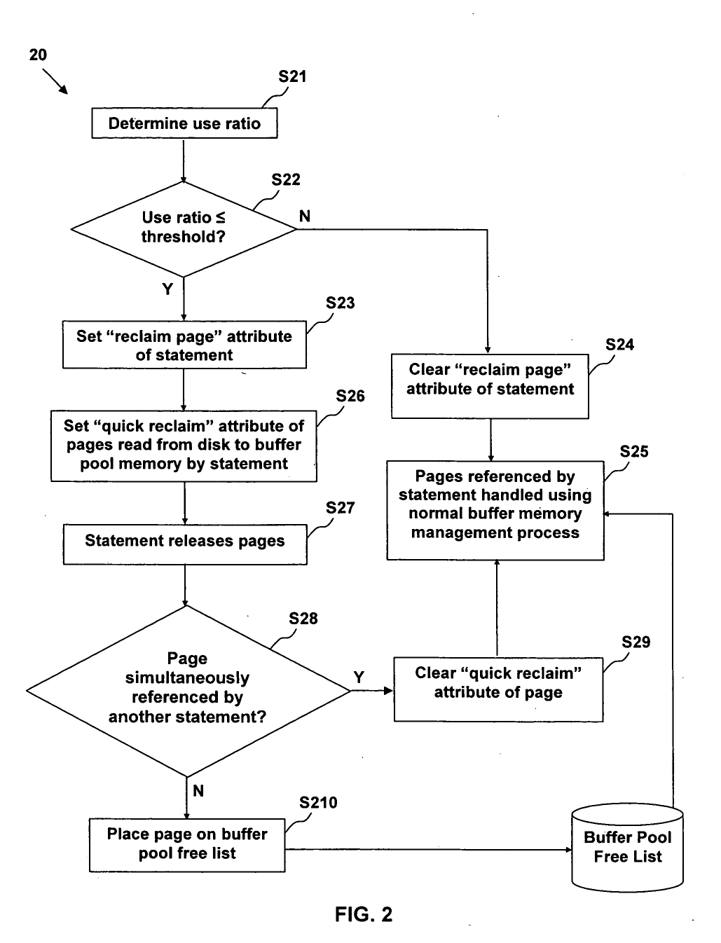

The above process is depicted in the flow diagram 20 illustrated in FIG. 2. In step S21, the use ratio for a statement is determined, either from statement history, or from statement cache statistics. In step S22, the use ratio is compared to a threshold value. If the use ratio is less than or equal to the threshold value, then in step S23 the “reclaim page” attribute of the statement is set. If the use ratio is greater than the threshold value, then in step S24 the “reclaim page” attribute of the statement is cleared, and the pages referenced by the statement are handled using a normal buffer memory management process (step S25). In step S26, the “quick reclaim” attribute of each page read from disk to buffer pool memory by the statement is set (pages read directly from the buffer memory pool by the statement are handled using normal buffer memory management process). In step S27, after execution of the statement, the pages are released. In step S28, if any of the released pages are simultaneously referenced by another statement, then in step S29 the “quick reclaim” attribute of those pages is cleared and the pages are handled using a normal buffer memory management process (step S25). Those pages with the “quick reclaim” attribute set and which are not simultaneously referenced by another statement are placed in a buffer pool free list (step S10) and their memory locations within the buffer pool memory are immediately available for re-use. Before attempting to acquire a page using the buffer pool memory's normal (e.g., LRU or FIFO) memory management process (step S25), the pages in the buffer pool free list are used. This allows the pages currently in the buffer pool memory to remain there longer, thus reducing disk reads, increasing hit rates, and reducing application response time.

By recognizing statements with low use ratios, the database buffer management system can reclaim buffer pool memory more quickly. This reduces the impact of the low re-use statement, since the database buffer management system does not retain as many pages in the buffer pool memory for the statement. Hence, it may not be necessary to move a table referenced by the SQL statement into a separate buffer pool to constrain the table's buffer pool memory use. By taking the use ratio of statements into account, the database adapts its memory management to specific statements, and thus reduces the need for customers to perform complex buffer pool analysis.

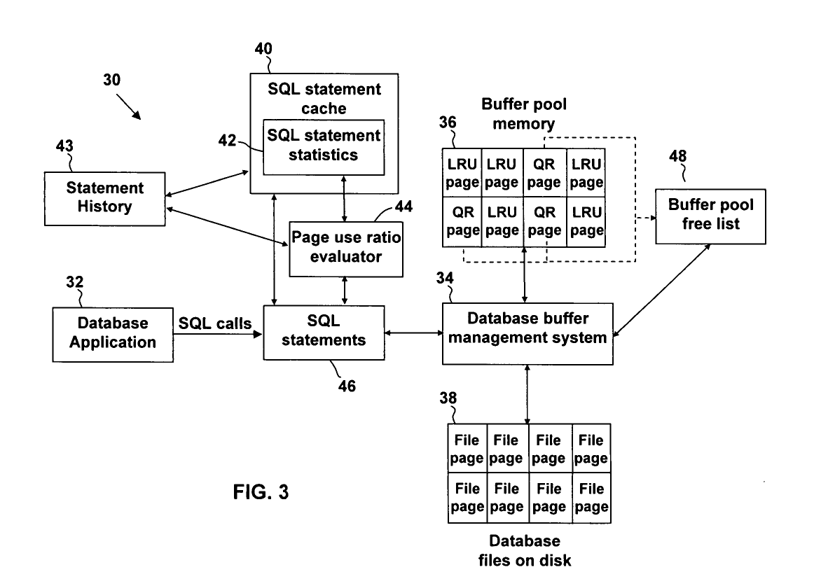

A system 30 for implementing the present invention is illustrated in FIG. 3. System 30 generally comprises a database application 32, database buffer management system 34, buffer pool memory 36, and a disk 38 containing database files. Also provided are an SQL statement cache 40, SQL statement statistics 42 for the statement cache 40, and a SQL statement history 43. A page use ratio evaluator 44 is provided to generate a use ratio for the SQL statements 46 generated by database application 32, either from the SQL statement statistics 42 or from the SQL statement history 43. If the use ratio of a statement 46 is less than or equal to a threshold value, a “reclaim page” attribute of the statement is set. If the use ratio of a statement is greater than the threshold value, then the “reclaim page” attribute of the statement is cleared, and the pages referenced by the statement are handled using a normal buffer memory management process (e.g., LRU) carried out by the database buffer management system 34.

If the “reclaim page” attribute of an SQL statement is set, and any pages referenced by the statement 46 are not located in buffer pool memory 36 and are therefore read from disk 38, then a “quick reclaim” attribute of the pages read from disk 38 to the buffer pool memory 36 is set. In FIG. 3, pages with their “quick reclaim” attribute set are indicated as “QR” pages, while those pages with their “quick reclaim” attribute cleared are indicated as “LRU” pages (assuming that an LRU buffer memory management process is being carried out by the database buffer management system 34). Upon release of a “QR” page by a statement 46, and if the “QR” page is not concurrently being used by another statement 46, the “QR” page is placed on the buffer pool free list 48 and its memory location in the buffer pool memory 36 is immediately available for re-use by the database buffer management system 34. The pages in the buffer pool free list 48 are used by the database buffer management system 34 before any of the LRU pages in the buffer pool memory 36, thus allowing the LRU pages currently in the buffer pool memory to remain there longer.

The statement cache statistics used to implement this process can be collected for table and index accesses, using, for example, the following indicators:
(A) TABLES:
   (1) random getpages—number of pages referenced randomly
   (2) sequential getpages—pages referenced in sequential (prefetch/scan) operations
   (3) synchronous I/Os (each reads a single page)
   (4) prefetch I/Os (each can read many pages)
   (5) pages retrieved by prefetch I/O
(B) INDEXES:
   (1) random getpages—number of pages referenced randomly
   (2) sequential getpages—pages referenced in sequential (prefetch/scan) operations
   (3) synchronous I/Os (each reads a single page)
   (4) prefetch I/Os (each can read many pages)
   (5) pages retrieved by prefetch I/O

The statistics for the SQL statement cache are periodically extracted and processed to calculate use ratios for statements. By periodically extracting and analyzing the SQL statement statistics, the system can adapt to changes in the run-time characteristics of statements, and if the use ratio of a statement changes, then the statement attributes can be changed. Since statements enter and leave the SQL statement cache based on the time and frequency of statement executions, page use statistics could be saved outside the statement cache for later recognition.

As described above, use ratios can be calculated as follows:
use ratio=(pages referenced by a statement)/max((pages read from disk for the statement),1)
which is equal to:
(random getpages+sequential getpages)/max((synchronous I/O+pages retrieved by prefetch I/O),1).
A use ratio can be calculated for both tables and indexes. X and Y below are symbols representing specific limits (“use ratio limit”) for indexes and tables, respectively, which would be set for identifying use ratios that make a statement eligible for special handling.

If an index use ratio is ≦X, then the attribute “reclaim index pages” is set on the statement. If the index use ratio is >X, then the attribute “reclaim index pages” is cleared on the statement. If the table use ratio ≦Y, then the attribute “reclaim table pages” is set on the statement. If the table use ratio >Y, then the attribute “reclaim table pages” is cleared on the statement. All index pages read from disk into buffer pool memory by a statement having the “reclaim index pages” attribute set are assigned a “quick reclaim” attribute. All table pages read from disk into buffer pool memory by a statement with the “reclaim table pages” attribute are assigned a “quick reclaim” attribute. When a statement having the “reclaim index pages” or “reclaim table pages” attribute is executing and releases a page which has the “quick reclaim” attribute set, and the page is not simultaneously referenced by another thread, then the page is placed on a buffer pool free list, and its memory location in the buffer pool memory is immediately available for re-use by the database buffer management system. If the page is simultaneously referenced by another thread when it is released, the “quick reclaim” attribute is cleared on the page.

When any statement requires a buffer in a buffer pool memory, the database buffer management system first checks the buffer pool free list for that buffer pool memory for pages, before attempting to acquire a page using the buffer pool memory's normal (e.g. LRU or FIFO) memory management process. If a statement running with “reclaim index pages” cleared references an index page in buffer pool memory which has the “quick reclaim” attribute set, the “quick reclaim” will be cleared, so that the page will be managed via the normal buffer pool memory management process. If a statement running with “reclaim table pages” cleared references a table page in buffer pool memory which has the “quick reclaim” attribute set, the “quick reclaim” will be cleared, so that the page will be managed via the normal buffer pool memory management process.

The values set for the “use ratio limit” X or Y would determine how conservative the process is in finding statements for special handling. For example, if X=1.0, then index pages would be subject to fast reclaim only if every index page used by the statement had been read in for the executing statement. As a further example, for Y=1.50, then table pages referenced by a statement would be subject to quick reclamation if the statement performed ≦50 page re-uses for every 100 pages read from disk for the statement. Further, the “use ratio limit” shows the value of buffer pool memory. As described above, the use ratio is a measure of how distinct the data referenced by the statement is from data used by the rest of the system. A “use ratio limit” of X=1.0 (the statement read all its pages in from disk) denotes that we will accept reading in and doing normal buffer pool memory management for pages which have a near zero likelihood of re-used. A use ratio limit of 1.5 denotes that we will accept pages being read into and retained in buffer pool memory if there is about a 33% (50 of 150) likelihood of being re-used. Thus a “use ratio limit” of 1.0 places a low value on buffer pool memory, while a higher “use ratio limit” places a higher value on buffer pool memory, as a higher “use ratio limit” will result in more aggressive page reclaims and fewer pages with low re-use expectations being resident in buffer pool memory.

SQL statement statistics for databases such as DB2, Oracle, and Informix currently aggregate the statistics for all tables and indexes joined in a single SQL statement into a single statistics entry. If this single statistics entry for a join statement is used in the present invention, the above process would function as described below.

If all frequently accessed (i.e. high getpage) tables in a join have low use ratio, then it is clear that the SQL statement statistics for the join would have a low use ratio. In this case the pages read in by and referenced by the executing join statement could be placed on the buffer pool free list when released. If, however, some of the tables have low use ratios, and some high, such that the statement use ratio for tables exceeded Y, then the SQL statement statistics would not have a low use ratio, and the pages referenced by the join would go through normal buffer page management. Similarly, use ratios could be calculated for the indexes used in the join, and would be treated as described above for tables.

In order for this process to recognize different use ratios for different database tables/indexes in a single SQL statement that is a join, the statement-level statistics described above could be extended. For each statement, the following statistics could be collected for each unique database object (table, index) used in the join statement. To reduce the storage requirements and data volumes for statement statistics, statement statistics extended with object IDs could be configured to retain statistics for the N objects with the most getpages in the join statement.
(A) TABLES:
   (1) random getpages—number of pages referenced randomly
   (2) sequential getpages—pages referenced in sequential (prefetch/scan) operations
   (3) synchronous I/Os
   (4) prefetch I/Os
   (5) pages retrieved by prefetch I/O
   (6) Unique Object Identifier
(B) INDEXES:
   (1) random getpages—number of pages referenced randomly
   (2) sequential getpages—pages referenced in sequential (prefetch/scan) operations
   (3) synchronous I/Os
   (4) prefetch I/Os
   (5) pages retrieved by prefetch I/O
   (6) Unique Object Identifier
      The use ratio for each object would then be calculated and the “use ratio limit” set, as described above.

In the present invention, statement use ratios and object statistics can be used to change management of pages in a buffer pool memory. For example, if the index use ratio for a specific object is ≦X, then the attribute “objectID reclaim index pages” would be set on the statement. objectID as used herein denotes the specific unique database object identifier. If the index use ratio for a specific object is >X, then the attribute “objectID reclaim index pages” would be cleared on the statement. If the table use ratio for a specific object ≦Y, then the attribute “objectID reclaim table pages” would be set on the statement. If the table use ratio for a specific object >Y, then the attribute “objectID reclaim table pages” would be cleared on the statement. All index pages for objectID that are read from disk into buffer pool memory by a statement with the “objectID reclaim index pages” attribute set are assigned a “quick reclaim” attribute. All table pages for objectID that are read from disk into buffer pool memory by a statement with the “objectID reclaim table pages” attribute set are assigned a “quick reclaim” attribute. When a statement having the “objectID reclaim index page” attribute set is running and it releases an objectID index page which has the “quick reclaim” attribute set, and the page is not simultaneously referenced by another thread, then the index page would be placed on a buffer pool free list, and would be immediately available for re-use by the database buffer management system. If the page is simultaneously being referenced by another thread when it is released, the “quick reclaim” attribute on the page is cleared. When a statement having the “objectID reclaim table pages” attribute set is running and it releases an objectID table page which has the “quick reclaim” attribute set, and the page is not simultaneously referenced by another thread, then the table page would be placed on a buffer pool free list, and would be immediately available for re-use. If the page is simultaneously being referenced by another thread when it is released, the “quick reclaim” attribute on the page is cleared. When any statement requires a buffer in a buffer pool memory, the database buffer management system will first check the buffer pool free list of that buffer pool memory for pages, before attempting to acquire a page using the buffer pool memory's normal (e.g. LRU or FIFO) memory management process. When a statement running with “objectID reclaim index pages” cleared references an objectID index page which has the “quick reclaim” attribute set, then the “quick reclaim” attribute on the page will be cleared, so that the page will be managed via the normal buffer pool memory management process. When a statement running with “objectID reclaim table pages” cleared references an objectID table page which has the “quick reclaim” attribute set, then the “quick reclaim” attribute on the page will be cleared, so that the page will be managed via the normal buffer pool memory management process.

Other methods for calculating use ratios are possible. For example, since statements may be predominantly random or sequential, use ratios could also be calculated for only random or only sequential access, in the following way:
random use ratio=random getpages/max(synchronous random I/Os,1)
sequential use ratio=sequential getpages/max((synchronous sequential I/Os+pages retrieved by prefetch I/O),1)
where:
(1) random getpages—number of pages referenced randomly
(2) sequential getpages—pages referenced in sequential (prefetch/scan) operations
(3) synchronous random I/Os
(4) synchronous sequential I/Os
(5) prefetch I/Os
(6) pages retrieved by prefetch I/O
(7) Unique Object Identifier
   These use ratios could then be used to determine which statements are candidates for special handling.

As described above, page re-use can occur in two ways: (1) a statement references buffer pool memory pages read in from disk by another execution of some statement; or (2) a statement re-references buffer pool memory pages that it has read in from disk. The use ratios and SQL statistics cannot distinguish between these two different behaviors, but “reclaim pages” has a different impact on long running SQL statements, depending on which type of re-use is predominant in the statement.

If the page “use ratio” of a long running SQL statement (S) is >1 because the statement is referencing pages that were read in by another executing statement, then using a higher “use ratio limit” for this statement to change “reclaim pages” from cleared to set will have little impact on the performance of the statement, since quick reclaim of pages will not affect the likelihood that the statement will find its pages in buffer pool memory. “Quick reclaim” does not affect pages which are already in buffer pool memory, only those read in from disk by a statement.

If the page “use ratio” of a long running SQL statement (T) is >1 because the statement is re-referencing pages that it read in from disk, then increasing the “use ratio limit” to change the statement from “reclaim pages” cleared to “reclaim pages” set will cause the database buffer management system to quickly reclaim pages read in from disk by the statement, which will increase the likelihood that the statement will have to read data in more than once.

While it is not possible to tell in advance, using the SQL statement statistics, which type of re-use is being done by a statement, one can infer whether the statement re-uses its own pages by running the statement with “reclaim pages” set and cleared. If the performance of the statement is worse with “reclaim pages,” and the use ratio decreases (i.e., there is an increase in pages read in), then one can infer that the statement is not suitable for execution with “reclaim pages” set. This information can be saved outside the statement cache for later reuse. This offers a way to adaptively set the “use ratio limit,” and thus the “reclaim pages” attribute, on a per-statement basis for long running SQL statements. Since the performance of statements can be affected by many factors outside the statement itself, several executions with each setting might be needed, to determine whether the statement could run with or without “reclaim pages.”

The database management software could, through running statements with and without “reclaim pages,” gather information on the performance of the statement. For each statement, the following statistics would be collected:
(1) random getpages—number of pages referenced randomly
(2) sequential getpages—pages referenced in sequential (prefetch/scan) operations
(3) synchronous random I/Os
(4) synchronous sequential I/Os
(5) prefetch I/Os
(6) pages retrieved by prefetch I/O
(7) Unique Object Identifier
(8) Statement text
(9) reclaim pages settings used at execution
(10) Elapsed time
   For each unique statement text, by comparing the elapsed time, and use ratios for the same statement run on several occasions with “reclaim pages” set or cleared, the system can determine whether a statement with a higher use ratio is suitable for execution with “reclaim pages.” If “reclaim pages” is set, and the use ratio goes down and elapsed time goes up, the, the statement is likely to be re-using its own pages, and is not a good candidate for “reclaim pages.”

It should be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

It should also be appreciated that the teachings of the present invention can be offered as a business method on a subscription or fee basis. For example, a computer system could be created, maintained, supported, and/or deployed by a service provider that offers the functions described herein for customers.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A method for database buffer memory management, comprising:
inferring re-use of a page using Structured Query Language (SQL) statement cache statistics.

2. The method of claim 1, wherein the page comprises a page in a buffer pool memory.

3. The method of claim 1, further comprising:
determining a use ratio of a statement.

4. The method of claim 3, wherein the use ratio of the statement comprises:
use ratio=(pages referenced by the statement/max(pages read from disk for the statement),1).

5. The method of claim 3, further comprising:
comparing the use ratio of the statement to a threshold value; and
if the use ratio is less than the threshold value, setting a reclaim page attribute of the statement indicating a low likelihood of page re-use of pages referenced by the statement.

6. The method of claim 5, further comprising, if the reclaim page attribute of the statement is set:
setting a quick reclaim attribute of each page read from disk by the statement; and
after each page is released by the statement, placing the page in a buffer pool free list, wherein a memory location of the page in a buffer pool memory is immediately available for re-use.

7. The method of claim 6, further comprising:
comparing statement performance with the quick reclaim attribute of each page set and unset, to adaptively evaluate the performance of using quick reclaim on pages read in and referenced by the statement.

8. The method of claim 5, further comprising:
applying different use ratios to different statements.

9. The method of claim 6, further comprising:
saving the attributes of a statement outside a statement cache, for later reuse.

10. A system for database buffer memory management, comprising:
a system for inferring re-use of a page using Structured Query Language (SQL) statement cache statistics.

11. The system of claim 10, further comprising:
a buffer pool memory, wherein the page comprises a page in the buffer pool memory.

12. The system of claim 10, further comprising:
a system for determining a use ratio of a statement.

13. The system of claim 10, wherein the use ratio of the statement comprises:
use ratio=(pages referenced by the statement/max(pages read from disk for the statement),1).

14. The system of claim 12, further comprising:
a system for comparing the use ratio of the statement to a threshold value; and
a system for setting a reclaim page attribute of the statement indicating a low likelihood of page re-use of pages referenced by the statement, if the use ratio is less than the threshold value.

15. The system of claim 14, further comprising:
a buffer pool memory;
a system for setting a quick reclaim attribute of each page read from disk by the statement, if the reclaim page attribute of the statement is set; and
a system for placing each page in a buffer pool free list after release by the statement, wherein a memory location of the page in the buffer pool memory is immediately available for re-use.

16. The system of claim 15, further comprising:
a system for comparing statement performance with the quick reclaim attribute of each page set and unset, and for adaptively evaluating the performance of using quick reclaim on pages read in and referenced by the statement.

17. The system of claim 14, further comprising:
a system for applying different use ratios to different statements.

18. The system of claim 15, further comprising:
a system for saving the attributes of a statement outside a statement cache, for later reuse.

19. A program product stored on a recordable medium for database buffer memory management, which when executed comprises:
program code for inferring re-use of a page using Structured Query Language (SQL) statement cache statistics.

20. The program product of claim 19, wherein the page comprises a page in a buffer pool memory.

21. The program product of claim 19, further comprising:
program code for determining a use ratio of a statement.

22. The program product of claim 21, wherein the use ratio of the statement comprises:
use ratio=(pages referenced by the statement/max(pages read from disk for the statement),1).

23. The program product of claim 21, further comprising:
program code for comparing the use ratio of the statement to a threshold value; and
program code for setting a reclaim page attribute of the statement indicating a low likelihood of page re-use of pages referenced by the statement, if the use ratio is less than the threshold value.

24. The program product of claim 23, further comprising:
program code for setting a quick reclaim attribute of each page read from disk by the statement, if the reclaim page attribute of the statement is set; and
program code for placing each page in a buffer pool free list, wherein a memory location of the page in a buffer pool memory is immediately available for re-use, after the page is released by the statement.

25. The program product of claim 24, further comprising:
program code for comparing statement performance with the quick reclaim attribute of each page set and unset, to adaptively evaluate the performance of using quick reclaim on pages read in and referenced by the statement.

26. The program product of claim 23, further comprising:
program code for applying different use ratios to different statements.

27. The program product of claim 23, further comprising:
program code for saving the attributes of a statement outside a statement cache, for later reuse.

28. A method for deploying an application for database buffer memory management, comprising:
providing a computer infrastructure being operable to infer re-use of a page using Structured Query Language (SQL) statement cache statistics.

29. Computer software embodied in a propagated signal for database buffer memory management, the computer software comprising instructions to cause a computer system to infer re-use of a page using Structured Query Language (SQL) statement cache statistics.
